(19) United States
(12) Patent Application Publication
(10) Pub. No.: US 2016/0261133 A1
(43) Pub. Date: Sep. 8, 2016

(54) CELL PHONE PROTECTOR HAVING WIRELESS CHARGING AND DISCHARGING FUNCTION

(71) Applicant: COREMATE TECHNICAL CO., LTD., TAOYUAN COUNTY (TW)

(72) Inventor: Robert Wang, TAOYUAN COUNTY (TW)

(21) Appl. No.: 14/641,357

(22) Filed: Mar. 7, 2015

(51) Int. Cl. H02J 7/02; H02J 7/00; H04M 1/02

(52) U.S. Cl. CPC H02J 7/025; H04M 1/0254; H02J 7/0044

(57) ABSTRACT

A cell phone protector having a wireless charging and discharging function includes a flip cover and a protection case. The protection case is detachably disposed on the flip cover. The flip cover includes a power receiving induction coil and a power output induction coil above the power receiving induction coil. Both the power receiving induction coil and the power output induction coil are electrically connected with a rechargeable battery. The protection case is adapted to accommodate a cell phone. The rechargeable battery can be charged wirelessly through the power receiving induction coil. Through the power output induction coil, the flip cover can be used to charge the cell phone placed in the protection case wirelessly. When the protection case is detached from the flip cover, the flip cover can be used as a wireless power supply board.

### BACKGROUND OF THE INVENTION

1. Field of the Invention

The present invention relates to a protector, and more particularly to a cell phone protector having a wireless charging and discharging function.

2. Description of the Prior Art

With the advancement of science and technology and the development of information, a cell phone provides multiple functions, such as phone call, internet access, taking pictures, photography, navigation, and so on. Therefore, a cell phone has become an essential electronic apparatus. Because it is used heavily, this situation that the built-in battery is low often occurs. When the user is outdoors and cannot get the electricity to charge the battery, a mobile power pack can be used to charge the battery. However, the mobile power pack is large in size and has to be taken along. Furthermore, a wire is required for connect the mobile power pack and the cell phone. This way is inconvenient for use.

Accordingly, the inventor of the present invention has devoted himself based on his many years of practical experiences to solve this problem.

### SUMMARY OF THE INVENTION

The primary object of the present invention is to provide a cell phone protector having a wireless charging and discharging function able to charge a cell phone in a wireless way. It is very convenient for use.

In order to achieve the aforesaid object, the cell phone protector having a wireless charging and discharging function of the present invention comprises a flip cover and a protection case. The protection case is detachably disposed on the flip cover. The flip cover comprises a power receiving induction coil, a rechargeable battery electrically connected with the power receiving induction coil, a power output induction coil above the power receiving induction coil therein. The power output induction coil is electrically connected with the rechargeable battery. The protection case is adapted to accommodate a cell phone.

The flip cover of the cell phone protector having a wireless charging and discharging function of the present invention can get an external power through the power receiving induction coil to charge the rechargeable battery. Through the power output induction coil, the flip cover can be used to charge the cell phone placed in the protection case. When the protection case is detached from the flip cover, the flip cover can be used as a wireless power supply board.

### BRIEF DESCRIPTION OF THE DRAWINGS

FIG. 1 is an exploded view according to a first embodiment of the present invention;

FIG. 2 is a perspective view according to the first embodiment of the present invention;

FIG. 3 is a sectional view according to the first embodiment of the present invention;

FIG. 4 is a sectional view according to the first embodiment of the present invention when in use, showing the flip cover in a charging state;

FIG. 5 is a sectional view of the first embodiment of the present invention in another use state, showing the flip cover and the cell phone having a wireless charging function in a charging state;

FIG. 6 is a sectional view of the first embodiment of the present invention in a further use state as a wireless power supply board;

FIG. 7 is an exploded view according to a second embodiment of the present invention;

FIG. 8 is a perspective view according to the second embodiment of the present invention;

FIG. 9 is a sectional view according to the second embodiment of the present invention; and

FIG. 10 is a sectional view of the second embodiment of the present invention in a use state, showing the flip cover and the cell phone not having a wireless charging function in a charging state.

### DETAILED DESCRIPTION OF THE PREFERRED EMBODIMENTS

Embodiments of the present invention will now be described, by way of example only, with reference to the accompanying drawings.

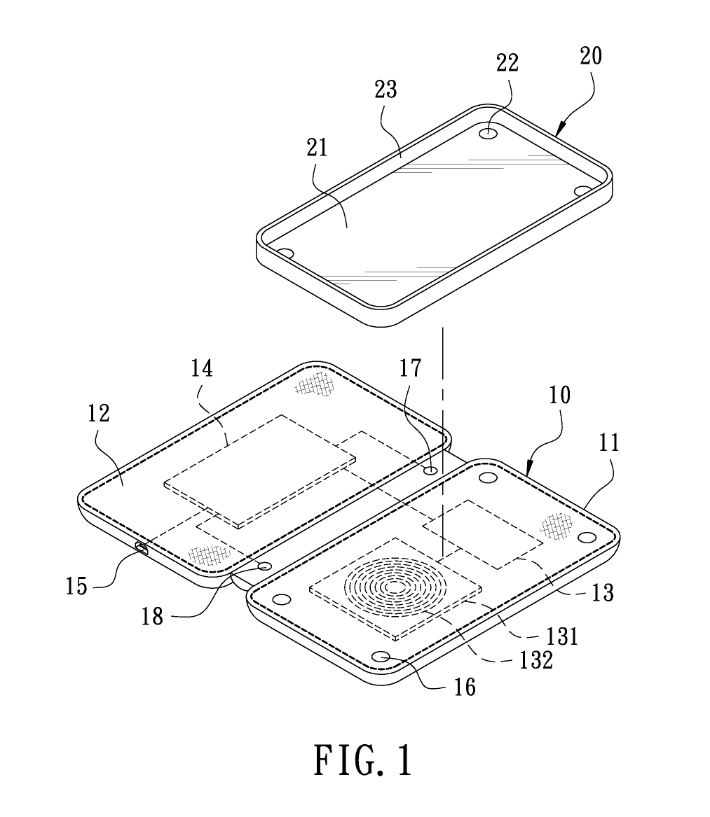

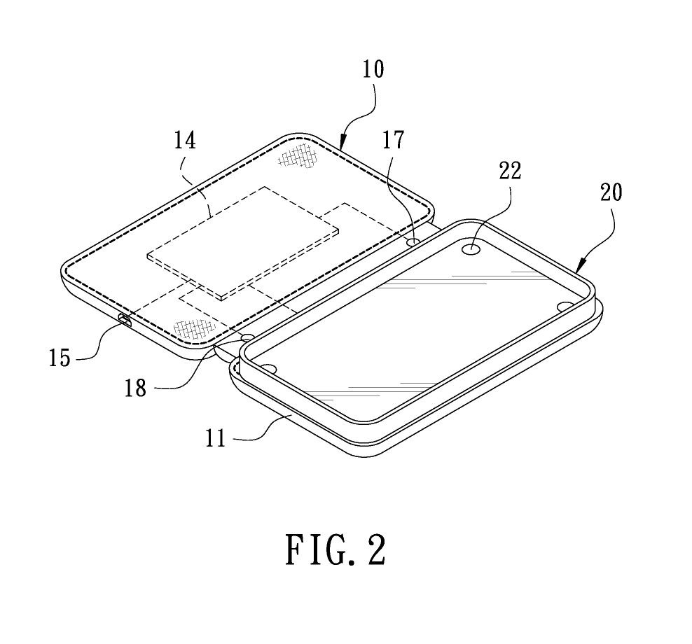

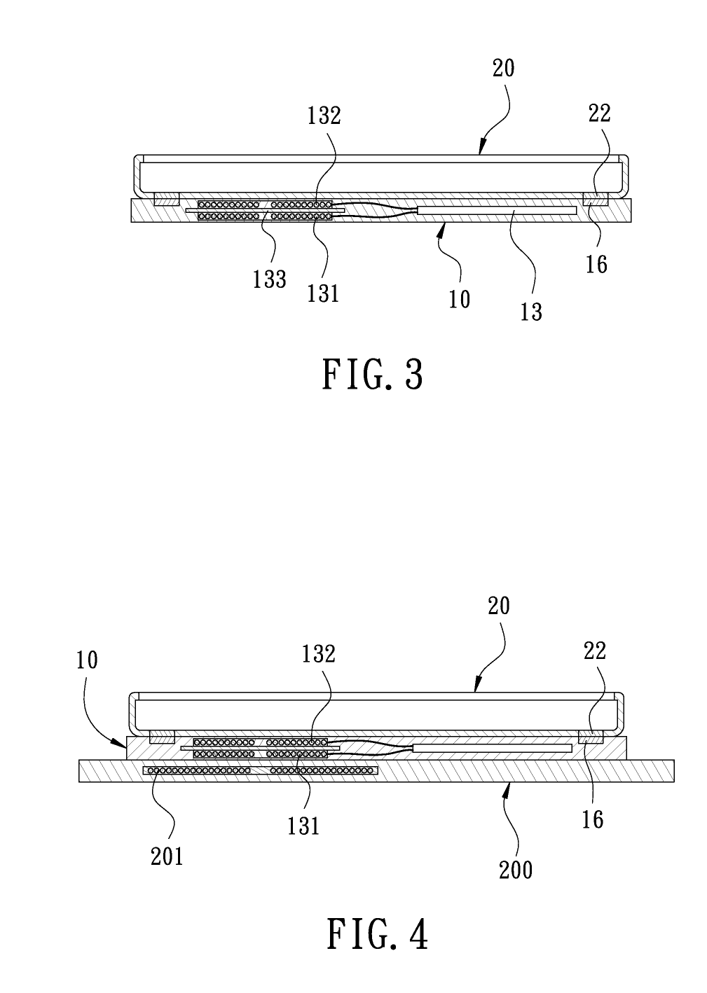

FIG. 1 is an exploded view according to a first embodiment of the present invention. FIG. 2 is a perspective view according to the first embodiment of the present invention. FIG. 3 is a sectional view according to the first embodiment of the present invention. The present invention discloses a cell phone protector having a wireless charging and discharging function. The present invention comprises a flip cover 10 and a protection case 20.

The flip cover 10 comprises a bottom pad 11 and an upper lid 12. One side of the upper lid 12 is integrally connected with one side of the bottom pad 11, so that the upper lid 12 can be opened or closed relative to the bottom pad 11. The bottom pad 11 of the flip cover 10 comprises a power induction module 13 therein. The power induction module 13 is electrically connected with a power receiving induction coil 131. The upper lid 12 of the flip cover 10 comprises an ultra-thin rechargeable battery 14 therein. The rechargeable battery 14 is electrically connected with the power induction module 13. The power induction module 13 further comprises a power output induction coil 132 above the power receiving induction coil 131. The power output induction coil 132 is electrically connected with the rechargeable battery 14. The power induction module 13 further comprises a spacer 133 between the power receiving induction coil 131 and the power output induction coil 132, such that the power receiving induction coil 131 and the power output induction coil 132 share the spacer 133 to separate the magnetic fields to avoid interference and reduce the size and thickness. The flip cover 10 has a port 15 for charging. The port 15 and the rechargeable battery 14 form an electric connection. The bottom pad 11 of the flip cover 10 is provided with a joint member 16. In this embodiment, the joint member 16 is a plurality of magnets. The flip cover 10 comprises a particle sensor 17 and a gas sensor 18 between the bottom pad 11 and the upper lid 12. The particle sensor 17 and the gas sensor 18 are electrically connected with the rechargeable battery 14 for getting the power source. The particle sensor 17 is adapted to sense the particles in the air and send a warning signal, such as the particles below PM2.5. The gas sensor 18 is adapted to sense a special gas and send a warning signal, such as alcohol concentration and carbon monoxide.

The protection case 20 is disposed on the bottom pad 11 of the flip cover 10. The protection case 20 has a bottom 21. The bottom 21 is also provided with a joint member 22 corresponding in position to the joint member 16 of the flip cover 10. In this embodiment, the joint member 22 is a plurality of magnets. The protection case 20 can be attracted on the bottom pad 11 of the flip cover 10 and detached conveniently. The protection case 20 is formed with a frame 23 extending upward from the bottom 21. The frame 23 is adapted to accommodate a cell phone.

FIG. 4 is a sectional view of the first embodiment of the present invention when in use, showing the flip cover 10 in a charging state. As shown in FIG. 4 and FIG. 1, when the flip cover 10 of the present invention needs to be charged, the flip cover 10 is placed on a wireless charging board 200. The wireless charging board 200 comprises a power output induction coil 201 therein. The power receiving induction coil 131 inside the bottom pad 11 of the flip cover 10 corresponds in position to the power output induction coil 201 of the wireless charging board 200. Thereby, the rechargeable battery 14 inside the flip cover 10 can be charged through the power receiving induction coil 131 to get the power from the wireless charging board 200.

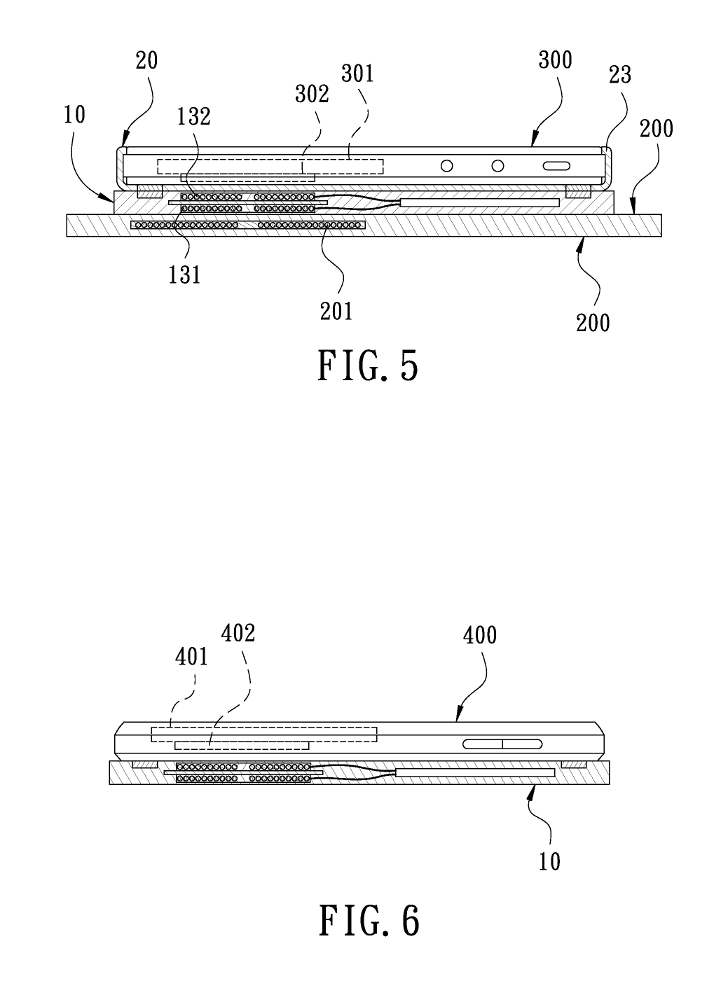

FIG. 5 is a sectional view of the first embodiment of the present invention in another use state, showing the flip cover and the cell phone having a wireless charging function in a charging state. As shown in FIG. 5 and FIG. 1, a cell phone 300 having a wireless charging function is placed in the protection case 20. The cell phone 300 comprises a rechargeable battery 301 therein and a power receiving induction coil 302 at the bottom thereof. The power receiving induction coil 302 is electrically connected with the rechargeable battery 301 for the rechargeable battery 301 to have a wireless charging function. When the cell phone 300 needs to be charged, the cell phone 300 with the flip cover 10 is placed on the wireless charging board 200. Through the power output induction coil 201 of the wireless charging board 200 and the power receiving induction coil 131 of the flip cover 10 to carry out electric coupling, the rechargeable battery 14 inside the flip cover 10 can be charged, and meantime through the power output induction coil 132 of the flip cover 10 and the power receiving induction coil 302 of the cell phone 300 to carry out electric coupling, the rechargeable battery 301 inside the cell phone 300 can be charged.

After charging, the cell phone is placed in the flip cover 10 and the protection case 20 for use. The cell phone can get the power not only from the built-in rechargeable battery but also from the rechargeable battery 14 of the flip cover 10 to extend the power of the cell phone.

FIG. 6 is a sectional view of the first embodiment of the present invention in a further use state as a wireless power supply board. As shown in FIG. 6 and FIG. 1, after the protection case 20 is detached from the flip cover 10, the bottom pad 11 of the flip cover 10 forms a flat plane as a wireless power supply board. The flip cover 10 can be used to charge an electronic apparatus having a wireless charging function. In this embodiment, the flip cover 10 is used to charge a cell phone 400 having a wireless charging function. The cell phone 400 comprises a rechargeable battery 401 therein and a power receiving induction coil 402 at the bottom thereof, such that the cell phone 400 can get the power from the rechargeable battery 14 of the flip cover 10.

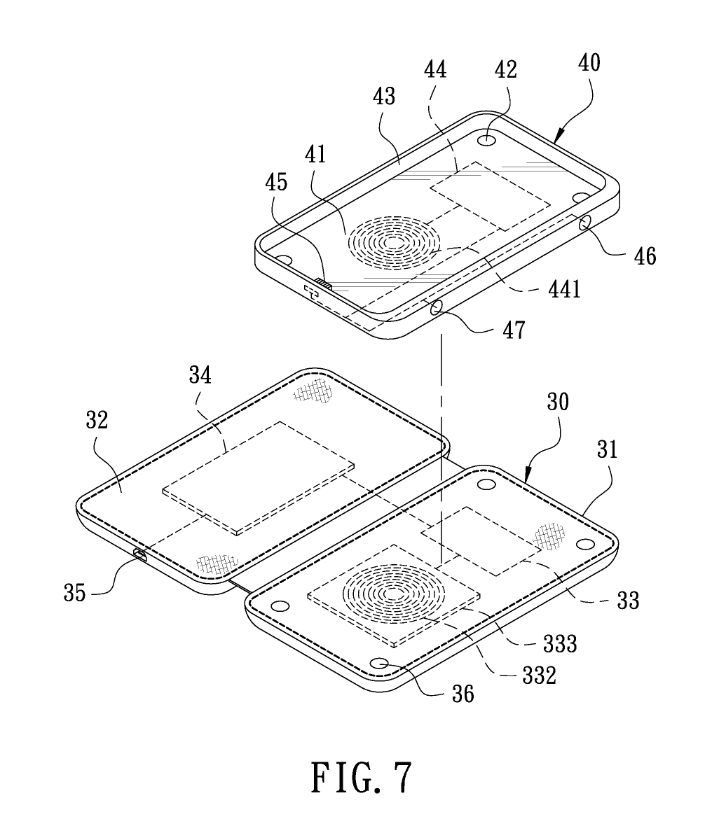

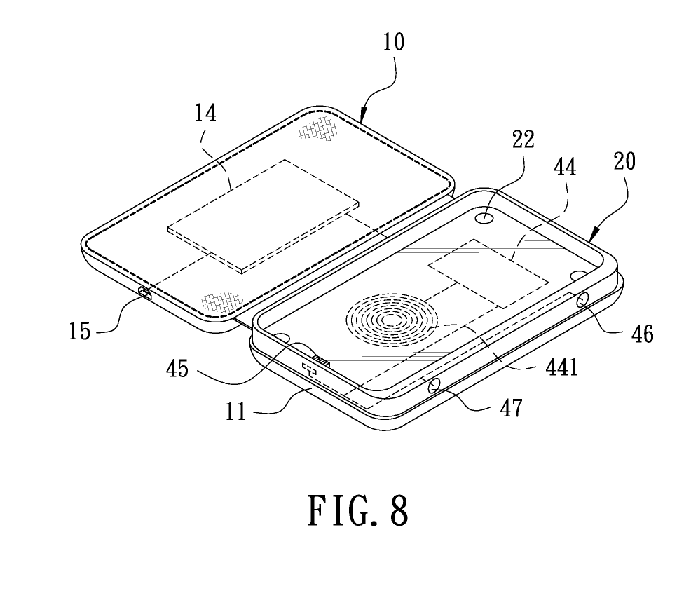

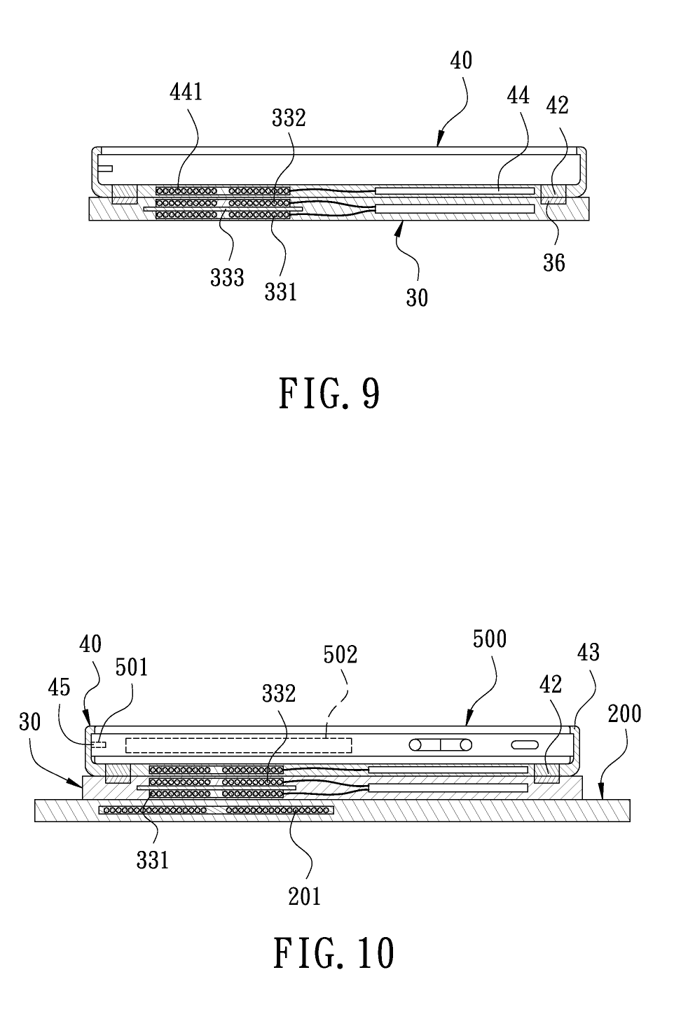

FIG. 7 is an exploded view according to a second embodiment of the present invention. FIG. 8 is a perspective view according to the second embodiment of the present invention. FIG. 9 is a sectional view according to the second embodiment of the present invention. A bottom 41 of a protection case 40 is provided with a power induction module 44. The power induction module 44 is electrically connected with a power receiving induction coil 441 corresponding in position to a power output induction coil 332 of a flip cover 30. A frame 43 of the protection case 40 is provided with a plug 45. The plug 45 is electrically connected with the power induction module 44 of the protection case 40. The plug 45 can be plugged to a power hole of a cell phone. The frame 43 of the protection case 40 is provided with a particle sensor 46 and a gas sensor 47. The particle sensor 46 and the gas sensor 47 are electrically connected with the plug 45, respectively, for getting the power source.

FIG. 10 is a sectional view of the second embodiment of the present invention in a use state, showing the flip cover and the cell phone not having a wireless charging function in a charging state. As shown in FIG. 10 and FIG. 7, a cell phone 500 not having a wireless charging function is placed in the protection case 40. The cell phone 500 has a power hole 501 for the plug 45 of the protection case 40 to be plugged therein. The power hole 501 is electrically connected with a rechargeable battery 502 provided in the cell phone 500. The power receiving induction coil 441 of the protection case 40 is electrically connected with the rechargeable battery 502 of the cell phone 500 for the rechargeable battery 501 of the cell phone 500 to have a wireless charging function. When the cell phone 500 needs to be charged, the cell phone 500 with the flip cover 30 as well as the protection case 40 is placed on the wireless charging board 200. Through the power output induction coil 201 of the wireless charging board 200 and the power receiving induction coil 441 of the protection case 40 to carry out electric coupling, the rechargeable battery 34 inside the flip cover 30 can be charged, and meantime through the power output induction coil 332 of the flip cover 30 and the power receiving induction coil 441 of the protection case 40 to carry out electric coupling, the rechargeable battery 502 inside the cell phone 500 can be charged.

The features and expected effects of the present invention are described as follows:

1. The flip cover of the present invention comprises the power receiving induction coil, the power output induction coil, and the rechargeable battery therein for charging in a wireless way. The present invention can be used conveniently, not charging in a wired way.

2. The flip cover of the present invention can supply the power directly instead of a conventional mobile power pack to extend the power of the cell phone. This can reduce carry-on articles.

3. The protection case of the present invention is detachable. After the protection case is detached from the flip cover, the protection case can be used as a wireless power supply board for a different cell phone or an electronic apparatus to be charged. The present invention provides multiple functions.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A cell phone protector having a wireless charging and discharging function, comprising:
a flip cover comprising a bottom pad and an upper lid, one side of the upper lid being integrally connected with one side of the bottom pad for the upper lid to be opened or closed relative to the bottom pad, the bottom pad comprising a power receiving induction coil therein, the flip cover comprising a rechargeable battery therein, the rechargeable battery being electrically connected with the power receiving induction coil, the bottom pad further comprising a power output induction coil above the power receiving induction coil, the power output induction coil being electrically connected with the rechargeable battery; and
a protection case detachably disposed on the bottom pad of the flip cover, the protection case having a bottom and a frame extending upward from the bottom, the frame being adapted to accommodate a cell phone;
wherein, the flip cover can get an external power through the power receiving induction coil to charge the rechargeable battery, through the power output induction coil, the flip cover can be used to charge the cell phone placed in the protection case, when the protection case is detached from the flip cover, the flip cover can be used as a wireless power supply board.

2. The cell phone protector having a wireless charging and discharging function as claimed in claim 1, wherein the bottom of the protection case is provided with a power receiving induction coil corresponding in position to the power output induction coil of the flip cover, the frame of the protection case being provided with a plug, the plug being electrically connected with the power receiving induction coil of the protection case, the plug being plugged into a power hole of the cell phone.

3. The cell phone protector having a wireless charging and discharging function as claimed in claim 1, wherein the flip cover has a port for charging, the port and the rechargeable battery forming an electric connection.

4. The cell phone protector having a wireless charging and discharging function as claimed in claim 1, wherein the bottom pad of the flip cover is provided with a joint member and the protection case is provided with another joint member corresponding in position to the joint member of the flip cover, such that the protection case is detachably disposed on the bottom pad of the flip cover.

5. The cell phone protector having a wireless charging and discharging function as claimed in claim 4, wherein the joint member of the flip cover is a plurality of magnets, and the joint member of the protection case is a plurality of magnets.

6. The cell phone protector having a wireless charging and discharging function as claimed in claim 1, wherein the flip cover further comprises a spacer between the power receiving induction coil and the power output induction coil.

7. The cell phone protector having a wireless charging and discharging function as claimed in claim 1, wherein the frame of the protection case is provided with a particle sensor.

8. The cell phone protector having a wireless charging and discharging function as claimed in claim 1, wherein the frame of the protection case is provided with a gas sensor.
